(19) United States
(12) Patent Application Publication
(10) Pub. No.: US 2007/0156469 A1
(43) Pub. Date: Jul. 5, 2007

(54) Airline management system generating routings based on stored customer preference data

(76) Inventors: Thomas K. Bird, Eagan, MN (US); Roger D. Hed, Eagan, MN (US); Robert T. Wilson, Minneapolis, MN (US)

Correspondence Address: UNISYS CORPORATION;MS 4773, PO BOX 64942, ST. PAUL, MN, 55164-0942, US

(21) Appl. No.: 11/321,509

(22) Filed: Dec. 29, 2005

(51) Int. Cl. G06Q 10/00

(52) U.S. Cl. 705/5

(57) ABSTRACT

The invention is directed to a computer environment in which a management system for a transportation carrier, e.g., an airline carrier, generates a list of routings based on preference data for a customer. The preference data includes data that may be used to select a particular routing, e.g., ticket class, seat assignment, meal service, airline, type of aircraft, connection points, connection times, fare, and an extended travel window. The preference data may be entered via a network user interface and stored in a central database. One or more profiles may be stored for a customer, such as a business profile, personal profile, or trip specific profiles. In this manner, when a user submits a search request, the management system generates a list of routings that satisfy the customer preference data. Furthermore, the management system may provide increased performance by reducing the number of search requests submitted by a customer.

### TECHNICAL FIELD

The invention relates to airline management systems and, more particularly, reservation and departure control systems, for generating routings in response to requests submitted by a customer.

### BACKGROUND

Existing airline management systems enable a customer to view airline routes that satisfy selected flight parameters before purchasing a flight ticket. For example, a customer may use an airline website to specify the type of trip, e.g., one-way, round trip, or multi-destination, origin and destination cities or airports, and departure and arrival dates and times. When the customer submits the request, the airline management system generates a list of every airline route that satisfies the request. The list of airline routes is generally displayed to the customer in a sorted order, such as in an ascending or descending price order, in order of shortest flights, in order of departure times, or in order of airlines.

However, a customer may purchase a ticket based not only on general flight parameters, but also personal preferences such as meal service, ticket classes, seat assignment, type of aircraft, connection points, connection times, fare, and other preferences. Consequently, the customer may search the list for the flight that best matches the specified flight parameters as well as a number of the customer's individual preferences.

For example, when interacting with an existing airline management system, a customer may submit multiple search requests for flights with a different number of connections, flights arriving at or departing from different airports, and flights departing over an extended period of time. For example, a customer may want to fly from Chicago, Ill. to New York, N.Y. In this example, the customer may submit a search request for flights from each airport in Chicago, Ill., i.e., O'Hare International airport (airport code ORD) and Midway International Airport (airport code MDW), to each airport in New York, N.Y., i.e., John F. Kennedy International Airport (airport code JFK) and LaGuardia International Airport (airport code LGA). The customer may then compare each of the routings from each list based on one or more preferences before purchasing an airline ticket.

In another example, a customer may submit multiple search requests for flights on multiple dates. In this case, a customer may want to depart from and arrive at specific airports, but wants to compare flights based on the departure and arrival dates. In particular, a customer may want to vacation in Orlando, Fla. for a week in February. Thus, the customer may, for example, submit search requests for flights that depart on a Saturday and return the following Saturday. Consequently, the customer may submit four search requests, or possibly more if the customer also wants to compare Sunday flights or weekday flights.

In any case, airline management systems generate a list including every routing that satisfies the standard flight information for each search request submitted by a customer. Consequently, in addition to generating a list including every flight that matches the standard flight information, airline management systems can also be burdened with multiple search requests.

### SUMMARY

In general, the invention is directed to a computer environment in which a management system for a transportation carrier, such as an airline carrier, generates a list of routings based on preference data for a customer. The customer preference data includes preference data that may be used to select a particular routing, e.g., ticket class, seat assignment, availability of meal service, airline, type of aircraft, connection points, connection times, fare, and extended travel window. The customer may select weights for each individual preference and set the priority of the preferences. For example, the customer may specify that the airline that provides the routings is more important than the particular connection points used in the routings. The preference data may be entered via a network user interface and stored in a central database. The customer may store one or more profiles, such as a business profile, a personal profile, or a trip specific profile. In this manner, when a user submits a search request, the management system generates a list of routings that satisfy the customer preference data. Furthermore, the management system may provide increased performance by reducing the number of search requests submitted by a customer.

As described herein, the airline management system provides a network user interface with which authorized users residing at remote stations interact to enter flight and preference data for a customer and submit a search request for a list of routings that satisfy the data. A user may include an agent interacting directly with the airline management system or a customer using an airline's website to search for possible flights. The user may interact with the airline management system to select preference data for an identified customer. Customer preference data may include preferences regarding the ticket class, seat assignments, meals, preferred connection points, connection points that are to be avoided, number of connections, connection times, time between connections, type of aircraft, airline, fare, extended travel window such as all dates within 30 days after a specified date, and other preferences that may be used to select a flight. In addition, the customer may weight each preference, i.e., select different levels of preference that determines how strongly to apply each preference. For example, a customer may indicate preference data by adjusting points on graphical indicators or selecting options provided by dropdown menus, e.g., strongly prefer, prefer, acceptable, avoid, and never. Furthermore, the customer may also set the priority of the preferences. As an example, the customer may want his or her flight to have the fewest number of connections and, therefore, selects the number of connections to have the highest priority.

The preference data is stored in a central database. A customer may store preference data for more than one profile. For example, a customer may store preference data for a business profile, personal profile, domestic profile, international profile, and trip specific profiles. Because the preference data is stored in a central database, the customer is not required to enter the preference data each time the customer visits an airline booking website. Storing the preference data may also reduce the number of search requests submitted by a user because the user may not have to submit multiple search requests. For example, a user may submit multiple search requests for flights with a different number of connections, flights arriving at or departing from different airports, and flights departing over an extended window of time. Using the example of flights departing over an extended period of time, the customer may want to use frequent flyer miles or award points accumulated from previous flight. In this case, the user may submit multiple search requests to find all weekend flights to Las Vegas, Nev. after a particular date.

When the user submits a search request, the user may first input data indicating the identity of the customer and general flight information, i.e., type of trip, such as one-way, round trip, or multi-destination, origin location, destination location, and departure and arrival dates and times. The customer may then input preference data or may select a profile containing previously entered preference data. The airline management system generates a list of routings that satisfies the flight and preference data in response to the search request. The airline management system and, more particularly, a routing engine, uses the customer preference data to only generate routings that satisfy the preference data. In this manner, the airline management system assists the customer in more easily purchasing an airline ticket that meets the customer's preferences. Moreover, the airline management system may provide increased performance because the airline management system may entirely avoid the use of an entire class of flights. For example, all flights on propeller planes may be avoided when generating the list of routings, which may reduce the number of search requests received from a customer.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary computer environment in which an airline management system generates a list of routings in accordance with an embodiment of the invention.

FIG. 2 is a block diagram illustrating an exemplary embodiment of the airline management system in further detail.

FIGS. 3 and 4 illustrate an exemplary user interface of the airline management system with which a customer interacts to select individual preferences.

FIG. 5 is a flowchart illustrating exemplary operation of the airline management system.

### DETAILED DESCRIPTION

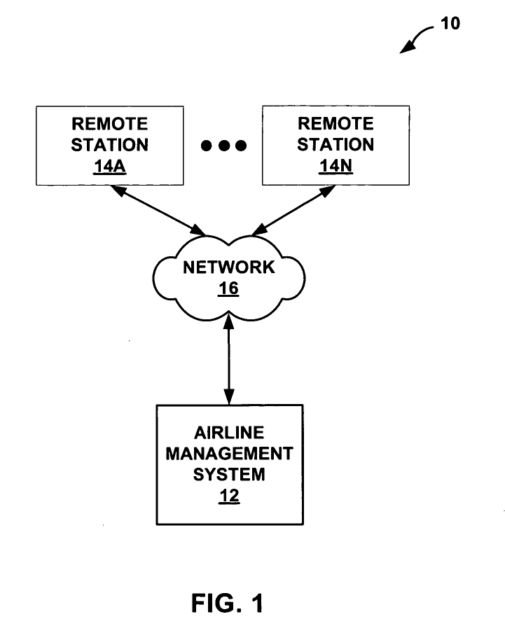

FIG. 1 is a block diagram illustrating an exemplary computing environment 10 in which airline management system 12 generates a list of routings based on preference data for a customer in response to a search request submitted by a customer. As described, airline management system 12 includes a routing module for generating and displaying a list of routings to customers and maintains a centralized repository, e.g., a database system, that stores preference data and allows the routing module access to the preference data in real-time. The central repository may store preference data such as ticket class, seating preference, meal service, airline, type of aircraft, connection points, connection times, fare, and extended travel window. The customer may weight each individual preference and set the priority of the preferences. For instance, a customer may indicate that the list of routings should be generated by giving the selected airline(s) a higher priority than selected connection points. The customer may store preference data for one or more profiles, such as a business profile, a personal profile, a domestic profile, an international profile, or a trip specific profile. Consequently, when a customer submits a search request, the airline management system 12 generates a list of routings that satisfies the preference data for the customer. In this manner, airline management system 12 provides increased performance by reducing the number of search requests submitted by a customer and reducing the number of routings generated by system 12.

As described in detail herein, airline management system 12 provides a user interface with which a user residing at remote stations 14A-14N (“remote stations 14”) interacts to submit a search request for a list of flights in accordance with preference data for the customer. A user may be, for example, a customer, an agent, or a user acting on the customer's behalf In particular, the search request may specify flight information and preference data. The flight information includes standard flight information, such as the type of trip, i.e., one-way, round trip, or multi-destination, origin location, destination location, and departure dates and times. The preference data may include ticket class, seat assignments, service availability, such as meals, special meals, movies, pet in cabin, bassinets, power connections, in-flight internet, and in-flight television, preferred connection points, connection points to be avoided, number of connections, connection times, type of aircraft (prefer or avoid), airline (prefer or avoid), departure times (prefer or avoid), arrival times (prefer or avoid), days of the week (prefer or avoid), interline connections (prefer or avoid), codeshare flights (prefer or avoid), service type (prefer or avoid) such as normal flights, shuttle flights, and surface flights, fare, extended travel window, sort order such as by preference, by departure time, ascending or descending price, or by flight time, preferred language for any free form text, e.g., information on new visa requirements, and other preferences that may be used to select a flight. In addition, the user may weight each preference, for example, by selecting different levels of preference that determines how strongly to apply each preference and also set the priority of the preference data. The user may set the priority of the preference data to, for example, select flights based on the airline before selecting flights based on connection points. In any case, remote stations 14 are generally associated with flight data stored by airline management system 12 and, thus, may be associated with flight data for a single airline or different airlines. In other words, airline management system 12 may generate a list of routings for multiple airline carriers based on preference data for a customer.

Airline management system 12 presents the user interface as one or more graphical screens (not shown) that allow the user to enter preference data and submit a search request for routings that satisfy the preference data. The user may reside at one of remote stations 14 and submit a search request to generate a list of routings in accordance with flight information and preference data. In this manner, airline management system 12 assists the user in purchasing an airline ticket in accordance with his or her preferences.

Airline management system 12 stores the preference data entered by a user in a database system and generates a list of routings in accordance with the preference data. Airline management system 12 may store preference data for more than one profile for a user. For example, a customer may store preference data for a business profile, personal profile, domestic profile, international profile, and one or more trip specific profiles. When a user submits a search request, airline management system 12 retrieves the customer's preference data relevant to the search request and generates a list of routings in accordance with the preference data. In this manner, airline management system 12 only generates routings that satisfy the preference data and, thus, may more efficiently generate a listing of routings by disregarding flights that do not satisfy the preference data. Consequently, rather than requiring the user to manually filter a list of routings that includes all flight that satisfy the flight information, airline management system 12 assists a user in more efficiently purchasing an airline ticket by only generating a list of routings that satisfy the flight information and the user's preference data. In other words, airline management system 12 returns a smaller list of routings, i.e., a list including fewer routings than is generated by a standard airline management system, that more closely fit the customer's preferences.

Each of the users associated with remote stations 14 typically accesses airline management system 12 via a network 16 using a remote computing device having suitable communication software such as a web browser. Network 16 be any private or public network, and may include one or more Local Area Networks (LANs), Wide Area Network (WANs), Wireless LANs or the like. Network 16 may also include one or more connected network devices (not shown), such as personal computers, laptop computers, handheld computers, workstations, servers, routers, switches, printers, fax machines or other devices.

A user may access airline management system 12 using a network-enabled computing device, such as a workstation, personal computer, laptop computer or a handheld device. The communication device executes the communication software in order to communicate with airline management system 12.

For example, remote stations 14 may include a computing device located within a user's, e.g., a customer's, home or other location and the customer may remotely access airline management system 12 via the Internet. In another example, one or more remote stations may be located within hotels, travel agencies, or other locations. As another example, a user may access airline management system 12 via a self service terminal within an airport or other location.

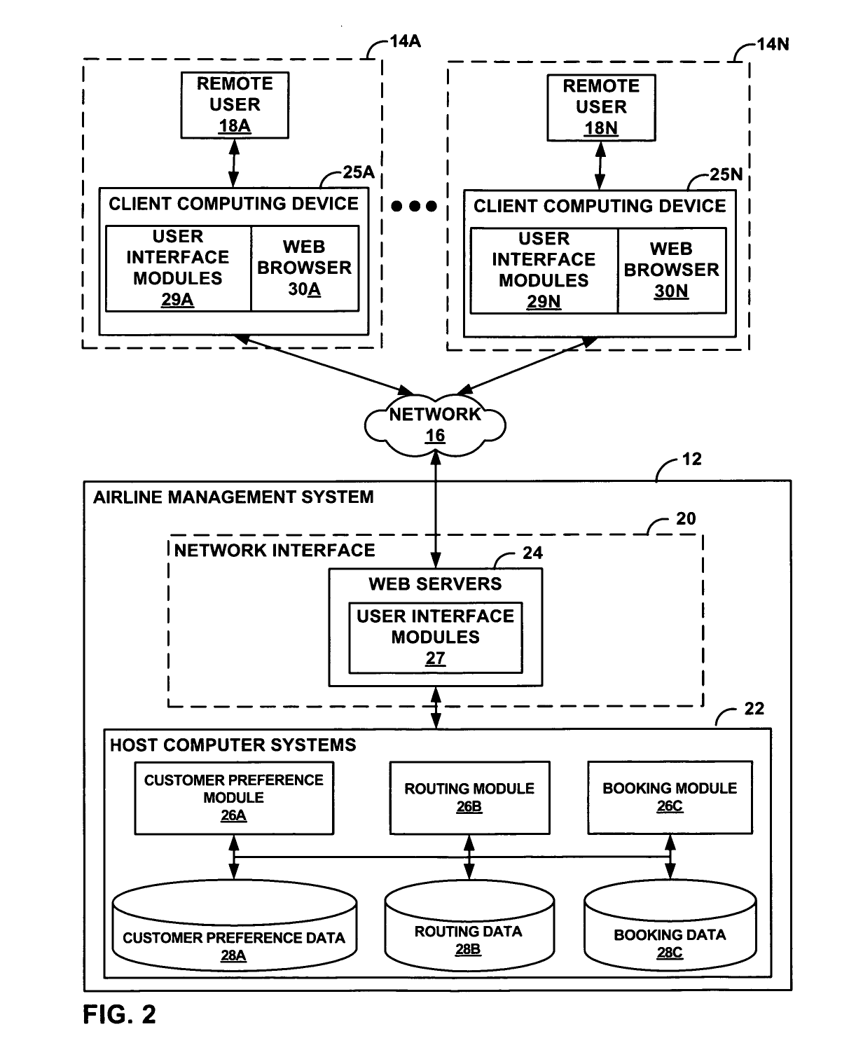

FIG. 2 is a block diagram illustrating an exemplary embodiment of airline management system 12 in further detail. In the exemplary embodiment, airline management system 12 includes one or more web servers 24 coupled to host computer systems 22. Web servers 24 provide a network interface 20 by which remote users 14 access host computer systems 22. Host computer systems 22 may be implemented as a distributed system including one or more servers executing the Unix, Windows®, or Linux operating system. Host computer systems 22 provide application servers and database systems to provide a computing platform for hosting airline management services for airline carriers. Example database systems include database systems manufactured by Sun Microsystems, Hewlett Packard, Unisys Corporation, Microsoft Corporation, and Oracle Corporation.

In general, host computer systems 22 execute a number of modules that provide airline management services for airline carriers. In the illustrated example, host computer systems 22 comprise a customer preference module 26A, a routing module 26B, and a booking module 26C. Remote users 18A-N (“remote users 18”) interact with customer preference module 26A to manage customer preference data 28A to submit a search request in order to assist the user in purchasing an airline ticket in accordance with their preference data. In other words, customer preference module 26A allows users 18 to create, retrieve, and update customer preference data 28A.

Unlike existing airline management systems which allow a user only to submit a search request for a list of routings that satisfy specified flight information, customer preference module 26A allows a user to submit a search request for a list of routings that satisfy specified flight information and the user's individual preferences. Typically, a user submits a search request for specific flight information, i.e., type of trip, such as one-way, round trip, or multi-destination, origin location, destination location, and departure dates and times. In response to the search request, the user receives a list of routings that satisfy the specific flight information. However, the listing may include a large number of routings. The routings in this list may not be presented to the user in any particular order. Consequently, the user is required to manually filter the list of routings in order to select the flight that best matches his or her requirements.

For example, a user may interact with customer preference module 26A to enter input indicating various preferences such as ticket classes, e.g., first class, business class, and coach, seat assignments such as window, aisle, center, or bulkhead, service availability, such as meals, special meals, movies, pet in cabin, bassinets, power connections, in-flight Internet, and in-flight television, preferred connection points, connection points to be avoided, number of connections, connection times, type of aircraft (prefer or avoid), airline (prefer or avoid), departure times (prefer or avoid), arrival times (prefer or avoid), days of the week (prefer or avoid), interline connections (prefer or avoid), codeshare flights (prefer or avoid), service type (prefer or avoid) such as normal flights, shuttle flights, and surface flights, fare, extended travel window, sort order such as by preference, by departure time, ascending or descending price, or by flight time, preferred language for any free form text, e.g., information on new visa requirements, and other preferences that may be used to select a flight.

A user may enter a ticket class as part of a search request when interacting with typical airline management systems. However, by interacting with preference module 26A to enter a preferred ticket class, the user may not be required to enter a ticket class when submitting a search class. Rather, the user may only be required to enter standard flight information

With respect to the user's preferred type of aircraft, the user may specify his or her preference to avoid flying on propeller planes or specify a preference for other types of aircraft. With respect to connection points, the user may specify one or more preferred connection points and/or one or more connection points to be avoided. The user may specify connection points by specifying a city or an airport code. With respect to fare, the user may specify a preferred range of cost. With respect to an extended travel window, a user may want to use frequent flyer miles or award points accumulated from previous flights. In this case, the user may prefer flights to a destination location after a specified date rather than on a specific date or one day before or after a specific date. The user may also enter a preferred extended time window if the user wants to find the cheapest weekend flight to a destination location during an upcoming month.

Customer preference module 26A may likewise be used to specify preferences related to booking a hotel and vehicle accommodations or preferred methods of payment. However, this type of preference information will not normally be a factor in selecting flights.

Customer preference module 26A allows a user to enter a level of preference which weights each of the customer's preferences. For example, the user may specify a level of a preference to select how strongly to apply each preference, e.g., prefer, acceptable, avoid at all cost, or never. The user may, for example, indicate the level of preference for a data item by selecting a value within a range of values by adjusting points on a graphical indicator or by selecting an option from a dropdown menu, such as strongly prefer, prefer, acceptable, avoid, and never.

In addition, the user may set the priority of the preference data. As an example, the user may want his or her flight to have the fewest number of connections. The user therefore selects the preferred number of connections to be zero and sets the number of connections to have the highest priority. In another example, the customer may select a flight based on the connection points rather than the airline. Accordingly, the user may set the priority of the connection points higher than the airline that provides the flights. The user may set the priority for each preference by assigning each preference a whole number value, e.g., assign the highest priority preference data the value of 1 and the lowest priority preference data a value equal to the number of different data items. In this manner, the user can set the priority of each preference

Users 18 may interact with customer preference module 26A to enter input indicating preferences for one or more profiles. Each profile is stored in customer preference data 28A. For example, a user may have a different set of preferences for a business profile, a personal profile, an international profile, a domestic profile, or one or more trip specific profiles. Because the preference data for each profile is stored in customer preference data 28A, the user may not be required to enter the preference data each time he or she submits a search request. As an example, a user that flies frequently for business may store his or her preferences in a business profile and, thus, may submit a search request in accordance with his or her business profile. A business profile may be particularly advantageous for a business that frequently flies sales personnel. In this case, each time a sales person is required to schedule a flight, the sales person or a user acting on behalf of the sales person can submit a search request in accordance with the general business profile.

In another example, a user may want to modify one or more preferences of his or her personal profile for different flights. In this case, the user may interact with customer preference module 26A to modify the desired preferences and save the preferences to the personal profile in customer preference data 28A. In this manner, the user only has to modify the desired preference data rather than being required to re-enter all of the preference data. This feature may also be particularly advantageous when creating a profile for a specific trip. For example, in a case wherein the user wants to enter preferences for a specific trip or vacation, the user may modify a profile created for a previous trip. The previous trip may contain several preferences which the user wants to keep, such as class of service, connections, airline, and aircraft type. Consequently, the user is only required to change the flight information and a subset of the available preferences. After changing the necessary preference data, the user may save the preference data as a different profile and submit a search request in accordance with the new profile. In any case, submitting a search request in accordance with a profile stored in customer preference data 28A enables the user to more efficiently purchase an airline ticket that meets the customer's individual preferences.

In general, routing module 26B receives the search request submitted by the user, and generates a list of routings in accordance with the preference data associated with the search request. In response to receiving the search request, routing module 26B may access customer preference data 28A in real-time to retrieve the appropriate customer preference data. In particular, the search request may only identify the flight information and the identity of the customer. Thus, routing module 26B accesses customer preference data 28A to retrieve the customer preference data associated with the identified customer and accesses routing data 28B. Routing data 28B stores departure and arrival times and locations, information regarding the class of services provided by a flight, the aircraft assigned to a given flight, information on fare classes, meal service availability on the flight, and other information related to customer preference data. Consequently, routing module 26B is able to generate a list containing only those routings satisfying the search request. In other words, routing module 26B generates a list of routings that includes fewer routings in comparison to a list of routings that is generated based only on standard flight information and that does not take into consideration customer preference data. In some embodiments, routing module 26B may present the list of routings in a prioritized order in accordance with the priority set by the user. As a result, a customer may not be required to manually filter the list of routings and thus, may more efficiently purchase an airline ticket in accordance with his or her preferences.

When a customer has selected a routing from the list of routings, booking module 26C manages booking data associated with airline flights and stores the data in booking data 28C. Booking data 28C stores information including passenger names, the number of segments in a journey, the routes associated with the flight number, special service requirements, or other booking-related information.

Host computer systems 22 may also comprise modules that manage other reservation and check-in services. For example, host computer systems 22 may also comprise a space module to control and track the space available on flights provided by a specified airline, departure module that manages the check-in process on the day of departure including the check-in of both passengers and baggage, and a reaccommodation module that manages all passenger-related activities that are performed because a flight re-scheduling event causes the original transportation plans to be changed.

Web servers 24 provide a seamless, network-based interface 20 by which remote users 18 access host computer systems 22. Web servers 24 provide a web-based interface by which users 18 communicate with airline management system 12 via network 16. In one configuration, web servers 24 execute web server software, such as software marketed by Microsoft Corporation under the trade designation “INTERNET INFORMATION SERVER.” As such, web servers 24 provide an environment for executing user interface modules 27. As described in detail below, user interface modules 27 provide an interface that allows users 18 to specify customer preference data and submit search requests to generate a list of routings in accordance with the customer's preference data. User interface modules 27 may include Active Server Pages, web pages written in hypertext markup language (HTML) or dynamic HTML, Active X modules, Java scripts, Java Applets, Distributed Component Object Modules (DCOM), and the like. User interface modules 27 may execute within an operating environment provided by web servers 24. Alternatively, portions of user interface modules 27 may be downloaded as “client-side” user interface modules 29A-29N that are executed on client computing devices 25A-25N, respectively. Client-side user interface modules 29A-29N could, for example, include Active X components or Java scripts executed by web browsers 30A-30N executing on client computing devices 25A-25N respectively.

As will be described in detail, user interface modules 27 interact with host computer systems 22 to allow remote users 18 to create, modify, and update customer preference data 28A and generate a list of routings in real-time. In one exemplary embodiment user interface modules 27 may generate an exemplary interface (not shown) in which remote users 18 interact to create, modify, or update a specific customer's preference data in customer preference data 28A and submit a search request in accordance with the preference data. Unlike airline management systems which generate a list of routings that includes every routing that satisfies standard flight information, airline management system 12 generates a list of routings that only includes routings in accordance with the customer's preference data associated with the search request. In particular, host computer systems 22 receive the search request to generate a list of routings in real-time in accordance with the customer's preference data. User interface modules 27 may then display the list of routings to assist the customer in purchasing an airline ticket.

By enabling users 18 to specify customer preference data and to generate a list of routings in accordance with the customer preference data, the performance of airline management system 12 may be increased. In particular, existing airline management systems may be burdened with multiple search requests for flights with the same standard flight information. These systems generate a list of all routings that match the standard flight information for each of the requests. For example, when interacting with an existing airline management system, a customer may submit multiple search requests for flights with a different number of connections, flights arriving at or departing from different airports, and flights departing over an extended period of time. For example, a customer may want to fly from Chicago, Ill. to New York, N.Y. In this example, the customer may submit a search request for flights from each airport in Chicago, Ill., i.e., O'Hare International airport (airport code ORD) and Midway International Airport (airport code MDW), to each airport in New York, N.Y., i.e., John F. Kennedy International Airport (airport code JFK) and LaGuardia International Airport (airport code LGA). The customer may then compare each of the routings from each list based on one or more preferences before purchasing an airline ticket. Additionally, the existing airline management system generates a list including every routing that satisfies the standard flight information for each search request.

In contrast, airline management system 12 may generate a list of routings that includes all routings of interest to the user in response to a single search request. Additionally, airline management system 12 generates a list of routings that includes only routings in accordance with the search request. Consequently, airline management system 12 may experience increased system performance by being burdened with fewer search requests and by only being required to generate a list of routings in accordance with the customer's preference data.

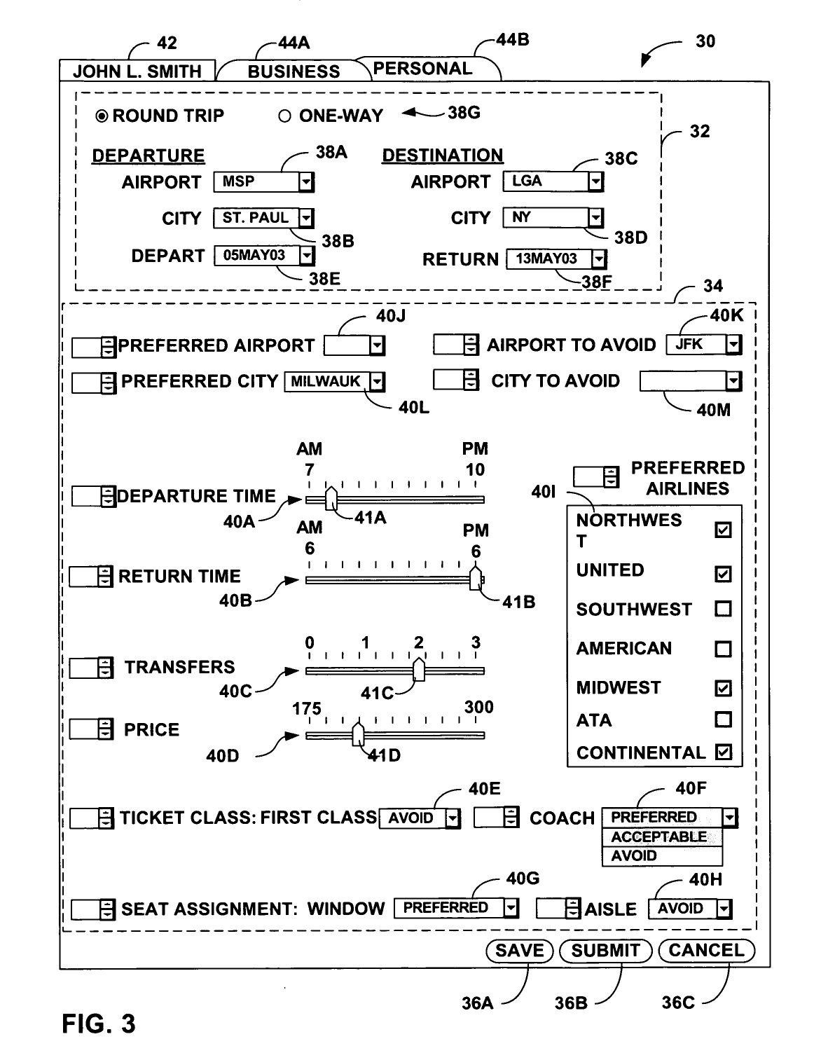

FIG. 3 illustrates an exemplary user interface 30 presented by user interface modules 27 for interacting with airline management system 12. In particular, user interface 30 allows users 18 to specify preference data for a search request.

User interface 30 includes a standard flight information input region 32 and a preference data region 34. In the example of FIG. 3, flight information input region 32 includes input areas 38A-G for specifying criteria for selecting an airline flight. More specifically, input areas 38A-G allow users 18 to input departure and destination information, including departure and destination airports, cities, depart and return dates, and the type of trip, i.e., round trip or one-way.

In the example of FIG. 3, input areas 38A-F of user interface 30 include dropdown menus listing possible selections for specifying departure and destination information as well as itinerary information. For example, the dropdown menu of input area 38A may include a list of all major United States airports. Alternatively, input areas 38A-G may be text input areas in which user 18 types a destination or other type of input areas. In any case, flight information input region 32 generally includes input areas for specifying standard flight information.

User interface 30 also presents preference data region 34 that includes input areas 40A-40N for specifying preference data that may be used to generate a list of routings. Preference data region 34 generally includes input areas that enable users 18 to specify preference data that may be submitted to host computer systems 22 with a search request in order to generate a list of routings that satisfy the customer's preferences. In the example of FIG. 3, input areas 40A-40M enable users 18 to input preferred connection airports and cities, connection airports and cities to avoid, departure times, return times, number of connections or transfers, price or fare, ticket class, seat assignment, and airlines. More specifically, input areas 40A-40D include graphical input selectors with corresponding set points 41A-41D. Set points 41A-41D are slidable within graphical indicators 40A-40D that visually represent the ranges of available options, e.g., characteristics associated with the set of items, and may be adjusted within the respective ranges.

Particularly, each of graphical indicators 40A-40F correspond to a different type of preference data and visually depicts a range for that data. For example, graphical indicator 40A corresponds to departure times for flights matching the search criteria input in region 32, and illustrates a range of available departure times from the selected airports and/or cities on the selected dates. Specifically, graphical indicator 40A illustrates that the departure times within the set of flights vary from 7 AM to 10 PM. Users 18 select the preferred departure time by selecting set point 41A within the selectable range of graphical indicator 40A.

Similarly, graphical indicator 40B represents a range of return flight times, graphical indicator 40C represents a range of the number of transfers, and graphical indicator 40D represents a range of the price. In some embodiments, the range represented by each of graphical indicators 40A-40D may be selected or automatically updated within region 34 based on the flight information input in search criteria region 32. In this manner, graphical indicators 40A-40D represent ranges of available options associated with the set of flights that match the criteria specified by search criteria input region 32.

Preference data region 34 may also include other types of input fields. For example, input areas 40E-40H include dropdown menus for selecting preferences with respect to ticket class and seat assignments. In particular, users 18 may interact with input areas 40E and 40F to set a preference for first class and coach class tickets, respectively, by selecting an option from a dropdown menu. In the example of FIG. 3, the user indicates that he or she prefers first class tickets. Input area 40G demonstrates the options that may be selected from input areas 40E-40H, i.e., preferred, acceptable, and avoid. Selecting “preferred” may indicate that the list of routings generated in response to a search request submitted with this information includes flights with first class tickets. Accordingly, the flights may be presented in an order displaying first class tickets first followed by flights with tickets for any “acceptable” class. Selecting “avoid” indicates that flights with only tickets of this class should not be included in the list of routings. Similarly, input areas 40G and 40H includes dropdown menus for selecting preferences for seat assignments, i.e., window and aisle seats.

Input area 401 may allow users 18 to select preferred airlines using a set of check boxes that correspond to a set of airlines listed within the input area. For example, input area 401 may include a list of all major United States airlines for domestic flights and may also include a list of international airlines for international flights.

Similar to input areas 38A-F, input areas 40J-40M include dropdown menus listing possible selections for inputting preferred connection airports and cities as well as connection airports and cities to avoid. In some embodiments, user interface 30 may include a plurality of preferred airports and cities and a plurality of airports and cities to avoid. Furthermore, in some embodiments, users 18 may select how strongly to apply the preference, as described with respect to input areas 40E-40H.

In addition, each of input areas 40A-40M includes a priority input field that allows users 18 to assign a priority to the corresponding preference data. Users 18 set or assign a priority by typing a whole number value in the input field associated with the preference data. As shown in FIG. 3, users 18 may also interact with arrow buttons associated with the priority input field to assign a priority to the corresponding preference data. For example, users 18 may assign the highest priority by specifying a value 1 in the input field corresponding to the desired preference data. The lowest priority value may be assigned a value equal to the number of input fields in region 34. Alternatively, priority input fields that are not assigned a whole number value may correspond to the lowest priority data.

In another example, the customer may prefer to select a flight based on the connection points rather than the airline. Accordingly, the user may set the priority of the connection points higher than the airline. The user may set the priority for each preference by assigning each preference a whole number value, e.g., assign the highest priority preference data the value of 1 and the lowest priority preference data a value equal to the number of different data items. In this manner, the user can set the priority of each preference

When the users 18 have specified flight information and preference data to their satisfaction for the customer identified by field 42, users 18 may activate one of buttons 36A-36C. Activating input button 36A causes the preference data selected within user interface 30 to be stored in customer preference data 28A. More specifically, the preference data is saved for the customer identified in field 42 and for the customer's active profile indicated by tab 44A. Tabs 44A and 44B enable users 18 to select different profiles associated with the identified customer. In some embodiments, the customer may also have an international profile, a domestic profile, and one or more trip specific profiles.

Users 18 may activate input button 36B to submit a search request in accordance with the preference data selected using interface 30. Host systems 22 receive the search request and generate a list of routings in accordance with the customer's preference data. Host systems 22 only generate routings that satisfy the preference data of user interface 30. When users 18 have assigned a priority to each one of preference data input fields 40A-40M, the list of routings may be displayed to users 18 in a corresponding prioritized order.

In some embodiments, user interface 30 may not include standard flight information input region 32. In such embodiments, standard flight information input region 32 is presented as part of a separate user interface. After a user inputs the necessary information, airline management system 12 may present user interface 30 including preference data region 34 to display preferences for the user's business profile. If the user does not desire to change any of the preferences, the user activates submit button 36B and airline management system generates a list of routings that satisfy the preference data. If the user changes data within data region 34 and activates save button 36A, the data stored in input areas 40A-M is stored in customer preference data 28A, i.e., changes to input fields 40A-M are stored in customer data 28A. Similarly, if the user activates submit button 36B after making changes to input areas 40A-M, the changes are stored in customer preference data 28B.

User interface 30 of FIG. 3 is merely exemplary and should not be considered limiting.

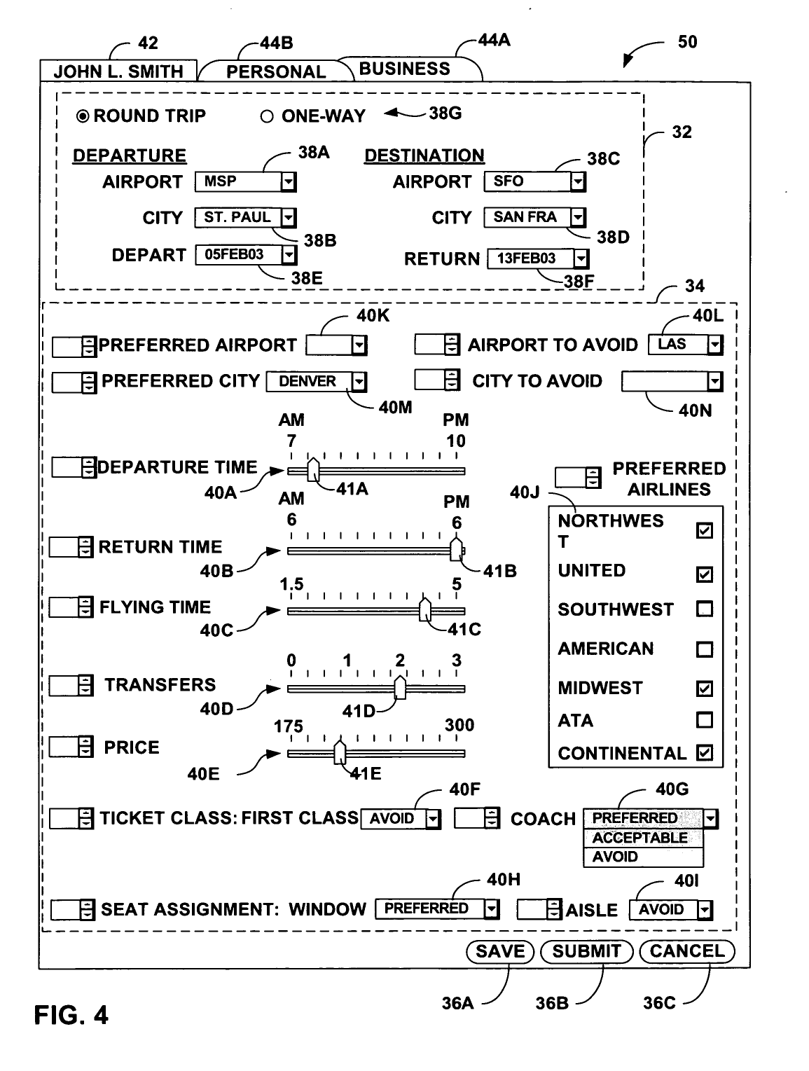

FIG. 4 illustrates an exemplary user interface 50 presented by user interface modules 27 for interacting with airline management system 12. In particular, user interface 50 allows users 18 to specify preference data for a search request in accordance with a personal profile for the same customer.

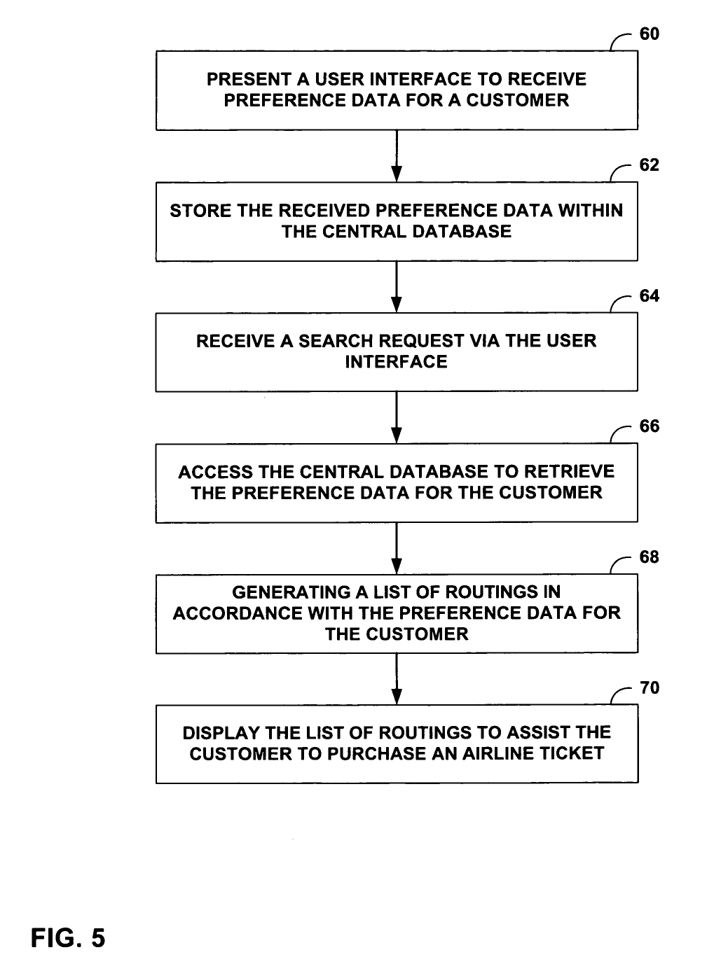

FIG. 5 is a flowchart illustrating exemplary operation of airline management system 12 for generating a list of routings in accordance with preference data for a customer. For purposes of illustration, the flowchart depicted in FIG. 5 will be described in reference to airline management system 12 of FIG. 2. Airline management system 12 includes a central database 28A for storing customer preference data and routing module 26B for generating a list of routings in accordance with customer preference data 28A for a customer.

Initially, user interface module 27 may present a user interface for receiving preference data for a customer (60). For example, user 18 may enter preference data for a particular profile, such as a business profile, a personal profile, an international profile, a domestic profile, or a profile for a specific trip. The preference data may include ticket class, seat assignment, meal service, airlines, types of aircraft, connection points, connection times, fares, and an extended travel window. In any case, the host computer systems 22 store the received preference data in a central database (62) that may be accessed in real-time.

Next, host computer systems 22 may receive a search request via user interface module 27 (64). The search request may include data indicating standard flight information and the identity of the customer. In response to receiving the search request, routing module 26B accesses the customer preference data 28A to retrieve the preference data for the identified customer (66) and generates a list of routings in accordance with the retrieve preference data for the customer (68). In order to generate the list of routings, routing module 26B may also access routing data 28B which stores route data such as departure and arrival times and locations, information regarding the class of services provided by a flight, the aircraft assigned to a given flight, information on fare classes, meal service availability on the flight, and other information related to customer preference data for each routing.

User interface module 27 displays the list of routings to assist the customer in purchasing an airline ticket that most closely fits the customer's individual preferences. Airline management system 12 may experience increased system performance by being burdened with fewer search requests and by only being required to generate routings in accordance with the customer's preference data.

Various embodiments of the invention have been described. Although the embodiments are described in terms of an airline for exemplary purposes, the techniques of the invention may be applied to improve the efficiency of generating a list of routings in accordance with preference data for a customer data in other transportation industries, such as bus and train lines, shipping and cruise services, and any other transportation industry. These and other embodiments are within the scope of the following claims.

1. A computer-implemented method comprising:
maintaining a central database of an airline management system to store preference data for a plurality of customers;
presenting a network user interface to receive input identifying one of the customers and to submit a search request for routings that satisfy preference data associated with the identified customer;
executing a routing module on a host computer system of the airline management system to access the central database, to retrieve preference data associated with the identified customer, and to generate a list of routings in accordance with the retrieved preference data in response to the search request; and
displaying the list of routings via the network user interface to assist the identified customer in purchasing an airline ticket.

2. The method of claim 1, wherein the preference data includes one or more of a preferred ticket class, a preferred seat assignment, a preferred service availability, a preferred aircraft type, an aircraft type to be avoided, a preferred airline, an airline to be avoided, one or more preferred connection points, one or more connection points to be avoided, a preferred number of connections, one or more preferred connection times, one or more preferred departure times, one or more departure times to be avoided, one or more preferred arrival times, one or more arrival times to be avoided, one or more preferred days of the week, one or more days of the week to be avoided, a preferred service type, a service type to avoid, a preferred cost, a preferred time window, a preferred sort order, a preferred language for documents, data indicating a preference for interline connections, and data indicating a preference for codeshare flights.

3. The method of claim 1,
wherein maintaining the central database comprises maintaining the central database to store one or more profiles for each of the customers, and
wherein each of the profiles is capable of storing different preference data.

4. The method of claim 1, further including presenting the network user interface to receive the preference data.

5. The method of claim 4, wherein presenting the network user interface to receive the preference data further comprises presenting the network user interface to receive input to assign a priority to different types of the preference data.

6. The method of claim 5, wherein displaying the list of routings comprises displaying the list of routings in an order based on the assigned priority of the preference data.

7. The method of claim 4, wherein presenting the network user interface to receive preference data further comprises presenting the network user interface to receive input to select a level of preference for one or more types of the preference data.

8. The method of claim 7, wherein executing the routing module to generate the list of routings comprises generating the routings in accordance with the selected levels of preference.

9. The method of claim 1, wherein the search request comprises at least one of an origin location, a destination location, a type of trip, a date of departure to the destination location, and a date of departure to the origin location.

10. The method of claim 1, wherein executing the routing module to access the central database and to generate the list of routings comprises accessing the central database and generating the list of routings in real-time.

11. An airline management system comprising:
one or more host computer systems that maintain a central database that stores preference data for a plurality of customers;
a routing module executing on at least one of the host computer systems; and
a user interface software module communicatively coupled to the routing module to present a user interface for submitting a search request for a list of routings for a selected one of the customers, and
wherein the user interface software module invokes the routing module to generate the list of routings in accordance with preference data associated with the selected customer in response to the search request.

12. The system of claim 11, further comprising a computer coupled to at least one of the host computer systems and wherein the user interface software module operates on the computer.

13. The system of claim 11, wherein the user interface software module provides the list of routings to assist the customer in purchasing an airline ticket.

14. The system of claim 11, wherein the preference data includes one or more of a preferred ticket class, a preferred seat assignment, a preferred service availability, a preferred aircraft type, an aircraft type to be avoided, a preferred airline, an airline to be avoided, one or more preferred connection points, one or more connection points to be avoided, a preferred number of connections, one or more preferred connection times, one or more preferred departure times, one or more departure times to be avoided, one or more preferred arrival times, one or more arrival times to be avoided, one or more preferred days of the week, one or more days of the week to be avoided, a preferred service type, a service type to avoid, a preferred cost, a preferred time window, a preferred sort order, a preferred language for documents, data indicating a preference for interline connections, and data indicating a preference for codeshare flights.

15. The system of claim 11,
wherein the host computer systems maintain the central database to store one or more profiles for each of the customers, and
wherein each of the profiles may include different preference data.

16. The system of claim 11, wherein the user interface software module presents the user interface to receive input that assigns a priority to different types of the preference data associated with the selected customer.

17. The system of claim 16, wherein the user interface software module presents the user interface to display the list of routings in an order based on the assigned priority of the preference data associated with the selected customer.

18. The system of claim 11, wherein the user interface software module presents the network user interface to receive input that selects a level of preference for one or more types of the preference data associated with the selected customer.

19. The system of claim 18, wherein the routing module generates the list of routings in accordance with the selected levels of preference.

20. The system of claim 11, wherein the search request comprises at least one of an origin location, a destination location, a type of trip, a date of departure to the destination location, and a date of departure to the origin location.

21. The system of claim 11, wherein the routing module accesses the central database and generates the list of routings in real-time.

22. A transportation management system comprising:
means for storing preference data for a plurality of customers;
means for receiving input identifying any one of the customers and for submitting a search request to obtain routings that satisfy preference data associated with the identified customer;
means for generating a list of routings in accordance with the preference data associated with the identified customer in response to the search request; and
means for providing the list of routings to assist the identified customer in purchasing a ticket.
